(19) United States
(12) Patent Application Publication
(10) Pub. No.: US 2008/0065900 A1
(43) Pub. Date: Mar. 13, 2008

(54) METHOD AND APPARATUS FOR BIOMETRICS

(76) Inventors: Yongjin LEE, Ansan-city (KR); Dosung AHN, Seongnam-city (KR); Kiyoung MOON, Daejeon-city (KR); Kyoil CHUNG, Daejeon-city (KR); Sungwon SOHN, Daejeon-city (KR)

Correspondence Address: LADAS & PARRY LLP, 224 SOUTH MICHIGAN AVENUE, SUITE 1600, CHICAGO, IL, 60604, US

(21) Appl. No.: 11/734,855

(22) Filed: Apr. 13, 2007

(30) Foreign Application Priority Data
Sep. 7, 2006 (KR) 10-2006-86266

(51) Int. Cl. H04L 9/32; G06F 7/52

(52) U.S. Cl. 713/186; 708/620

(57) ABSTRACT

An apparatus and method for biometrics are provided. The apparatus includes a user registration unit, a user authentication unit, and a transform key storing unit. The user registration unit store a second registration template that transforms a first registration template generated from user biological data using a random orthogonal matrix and random vector. The user authentication unit transforms a first authentication template generated from input biological data the random orthogonal matrix and random vector used in the user registration unit, comparing with the second registration template, and thus performs user authentication. The transform key storing unit provides the random orthogonal matrix and the random vector to the user registration unit and the user authentication unit.

### CLAIM OF PRIORITY

This application claims the benefit of Korean Patent Application No. 2006-86266 filed on Sep. 7, 2006 in the Korean Intellectual Property Office, the disclosure of which is incorporated herein by reference.

### BACKGROUND OF THE INVENTION

1. Field of the Invention

The present invention relates to a method and apparatus for biometrics, and more particularly, to a method and apparatus for biometrics, which provide a low false accept rate and have a capability of preventing an unauthorized user from analogizing biological data of a user from a template although biological data for authentication is disclosed.

2. Description of the Related Art

Biometrics is a service for confirming personal identity using a user's physical and behavioral characteristics. As a biometrics method using physical characteristics, face recognition, fingerprint recognition, and iris recognition were introduced. As a biometrics method using behavioral characteristics, gait recognition, and signature recognition were introduced. In general, biometrics apparatus creates a template having user's physical and behavioral characteristics and information and uses it to register and confirm a user. The template stored in the biometrics apparatus is called a gallery or a registration template. A template newly created from a user when a user requests authentication is called a probe or an authentication template.

A user is authenticated through comparing a gallery and a probe. There are many methods for comparing two templates. Among them, a comparison method using Euclidean distance or cosine has been widely used in case of a vector type template.

A biometrics system provides high safety and convenience because of using physical and behavioral characteristics. The biometrics system needs to store registration templates additionally. Therefore, users may have inhibitions because when such templates are disclosed, users' identities and unique biological characteristics can be disclosed at the same time. In order to overcome such a shortcoming, a method of encoding and storing user's templates using cryptography was recommended. However, a user's template should be decoded in order to perform matching whenever a user requests authentication and the risk of compromising users' templates still remain. In addition, encoding and decoding operations generally require a large amount of computation. Therefore, the efficiency of entire authentication system is degraded.

If the registration templates are disclosed although the registration templates are encoded, the disclosed registration templates must be dumped and biological data collected to create the disclosed templates cannot be reused because the newly crated templates from the same biological data has the same information with the disclosed templates and the disclosed templates can be abused at the authentication stage where templates should be decoded in order to perform matching process. That is, if the user's registration templates are disclosed, registration templates must be recreated using different biological data of corresponding users. However, the biological data of each user is limited. For example, each user has only one face and ten fingerprints. Dislike from a typical user authentication system using a password, the biometrics based user authentication system has a limited number of creating a new registration template.

### SUMMARY OF THE INVENTION

The present invention has been made to solve the foregoing problems of the prior art and it is therefore an aspect of the invention is to provide a method and apparatus for safely storing, using and managing biological data.

Another aspect of the invention is to provide a method and apparatus for preventing an authenticated user from analogizing user's biological data from a template although a created template is disclosed.

Still another aspect of the invention is to provide a method and apparatus for creating numerous new templates from identical biological data although a created template is disclosed.

Further another aspect of the invention is to provide a method and apparatus for reducing a false acceptance rate of a biometrics apparatus.

According to an aspect of the invention, there is provided an apparatus for biometrics including a user registration unit, a user authentication unit, and a transform key storing unit. The user registration unit generates a first registration template from biological data from a user, transforms the first registration template to a second registration template using a random orthogonal matrix and a random vector, and stores the second registration template. The user authentication unit generates a first authentication template from biological data from a user, transforms the first authentication template to a second authentication template using the random orthogonal matrix and the random vector used in the user registration unit, and performs user authentication by comparing the second authentication template with the second registration template stored in the user registration unit. The transform key storing unit provides a random orthogonal matrix and a random vector to the user registration unit and the user authentication unit as a transform key for template transformation.

According to another aspect of the invention, there is provided a method for transforming a registration template. In this method, a first registration template is generated from biological data inputted from a user who is a target for biometric recognition. Then, the first registration template is transformed to a second registration template using a random orthogonal matrix and a random vector. The second registration template is stored at a storing unit to be used for biometric recognition, and the first registration template is dumped.

According to another aspect of the invention for realizing the object, there is provided a method of authenticating a user. In this method, a first authentication template is generated from biological data inputted from a user requesting biometric. Then, the first authentication template is transformed to a second authentication template using a random orthogonal matrix and a random vector. Then, the second authentication template is compared with a second registration template that is transformed by the same method of transforming the first authentication template to the second authentication template.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a block diagram illustrating a biometrics apparatus according to an exemplary embodiment of the present invention;

FIG. 2 is a flowchart illustrating a method of transforming a registration template according to another embodiment of the present invention;

FIG. 3 is a flowchart illustrating a method of biometrics according to another embodiment of the present invention;

FIG. 4 is a graph showing a result of authenticating a face using a conventional method of face recognition;

FIG. 5 is a graph showing a result of authenticating a face using the conventional face recognition method with an authentication scheme proposed by Jeonil Kang, DaeHun Nyan, and KyungHee Lee in an article entitled “Two Factor Face Authentication Scheme with Cancelable Feature”, LNCS Vol. 3781, Page, 67-76; and

FIG. 6 is a graph showing a result of authentication a face using a biometrics method according to an embodiment of the present invention.

### DETAILED DESCRIPTION OF THE PREFERRED EMBODIMENT

Preferred embodiments of the present invention will now be described in detail with reference to the accompanying drawings.

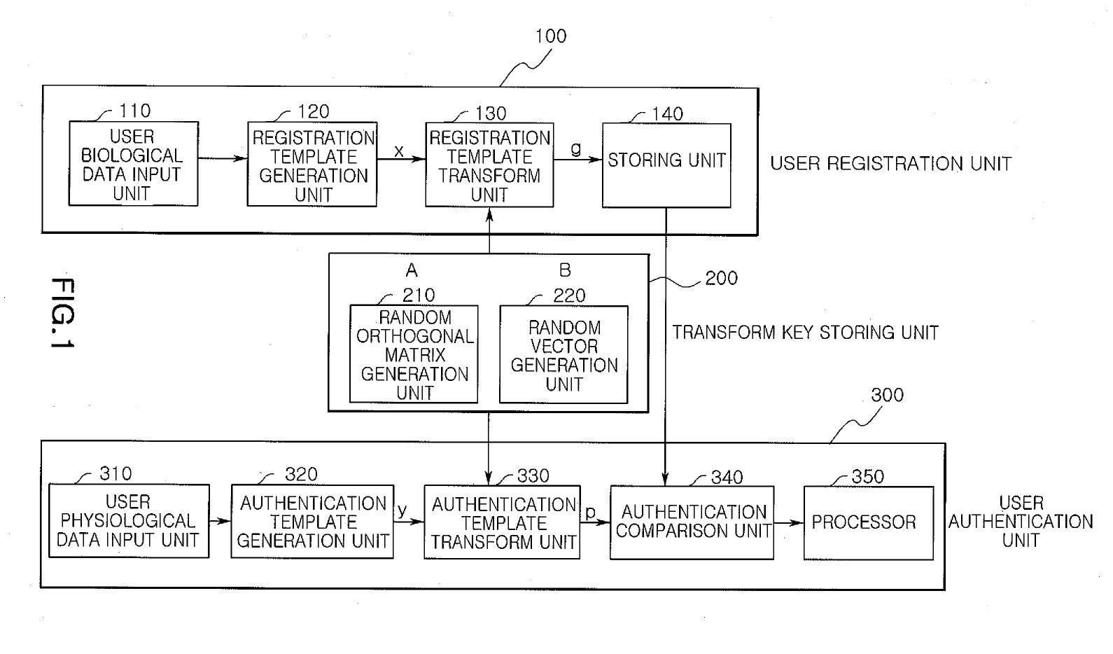

FIG. 1 is a block diagram illustrating a biometrics apparatus according to an exemplary embodiment of the present invention. Although the biometrics apparatus may include other elements except shown elements, necessary elements are shown in FIG. 1 for convenience.

Referring to FIG. 1, the biometrics apparatus according to the present embodiment includes a user registration unit 100, a transform key storing unit 200 which is independently stored by a manager and stores a transform key used for transforming a template, and a user authentication unit 300.

The user registration unit 100 composes a template, a standard data format, by extracting unique biological data from a user in order to create registration information for user authentication and stores the composed template. The user registration unit 100 includes a user biological data input unit 110, a registration template generation unit 120, a registration template transform unit 130, and a storing unit 140.

The user biological data input unit 110 measures a biometric entry such as a user's face, eyes, hands and voice, and obtains biological data of each entry. In order to measure the biometric entry, an optical recognition device such as an optical camera and a microphone can be used.

The registration template generation unit 120 generates an unique value based on the user's biological data obtained form the user biological data input unit to be used for user authentication, and composes a first registration template having a predetermined standard data format based on the generated unique value. The format of the first registration template varies according to the type of the biological data. For example, a fingerprint is expressed as a type of a feature point and a two dimensional coordinate thereof. An iris is expressed as a bit sequence, and a face is expressed as a vector. It is preferable that a template is a real number vector in the present embodiment.

The registration template transform unit 130 creates a second registration template by transforming the first registration template not to expose biological data of a user in the template although a registration template stored in a biometric system is disclosed to outside. As a preferable transforming method for the present invention, a method of creating transformed template using a random orthogonal matrix and a random vector is used. The random orthogonal matrix is a random matrix having the characteristics of Equation 1 and Equation 2. A method of transforming a first registration template x to a second registration template g using a random orthogonal matrix A and a random vector b is shown in Equation 3.
Λ⁻¹=Λ^{t} Equation 1
where, A⁻¹ is an inverse matrix of A, and A^{T} is a transpose matrix of A.
A^{t} A=AA=I Equation 2
where, I is an identity matrix having a same size of A.
g=Ax+b Equation 3

After transforming the template as like Equation 3, the second registration template g is stored in the storing unit 140 instead of storing the first registration template x that is created directly from the user's biological data. After storing, the first registration template x is removed.

The second registration template g is a random vector because the second registration template g is created using a randomly generated random matrix A and random vector b. Therefore, it is impossible to analogize the first registration template x from the second registration template g without the random matrix A and the random vector b. That is, the biological data of the user can safely stored by storing the second registration template g instead of storing the first registration template x.

If the second registration template g is disclosed, the second registration template g is dumped and a first registration template x is regenerated by receiving biological data from a user again. Then, a new second registration template g is generated using a new random orthogonal matrix A and a new random vector b. Although identical biological data is used, the newly generated second registration template is totally different from the disclosed second registration template because the new random orthogonal matrix A and the new random vector b are used. Therefore, if the template is transformed by the above described method according to the present embodiment, the method according to the present embodiment can unlimitedly generated new templates for user authentication.

The storing unit 140 stores only the transformed template from the registration template transform unit 130, and does not store the template before transforming the template.

The user authentication unit 300 receives biological data from a user who requests authentication and creates a first authentication template having a format identical to the second registration template stored in the storing unit of the user registration unit 100. The user authentication unit 300 includes a user biological data input unit 310, an authentication template generation unit 320, an authentication template transform unit 330, an authentication comparison unit 340 and a processor 350.

The user biological data input unit 310 measures a biometric entry such as face, hands, eyes and voice of a user and obtains the biological data for each entry. In order to secure the stable and reliable user authentication in the present embodiment, it is preferable to use an apparatus having an identical structure and interface of the user biological data input unit 110 of the user registration unit 100 in order to extract biological data from the biological data of the same user in an allowable error range.

The authentication template generation unit 320 generates a unique value from the obtained biological data from the biological data input unit 310 to be used for user authentication, and generates a first authentication template y having a predetermined standard data format based on the generated unique value.

In order to secure the stable and reliable user authentication in the present embodiment, it is preferable that the first authentication template y extracted from the authentication template generation unit 320 is a real number vector identical to the first registration template x generated at the registration template generation unit 120 of the user registration unit 100 in an allowable error range.

The authentication template transform unit 330 transforms the first authentication template y obtained from the authentication template generation unit 320 to a second authentication unit p using the identical transforming method used in the registration template transform unit 130 of the user registration unit 100. That is, the authentication template transform unit 330 uses the identical random orthogonal matrix A and random vector b, which were used in the registration template transform unit 130, with a method shown in Equation 4.
p=Ay+b Equation 4

The authentication comparison unit 340 compares the second authentication template p generated through the authentication template transform unit 330 and the second registration template g stored in the storing unit 140 of the user registration unit 100 in order to authenticate a user requesting a biometric recognition. As a comparison method applicable to the present embodiment, it is preferable to use a method of obtaining a Euclidian distance ∥g−p∥² between the two templates g and p.

The Euclidian distance ∥x−y∥² between the templates x and y, which are directly generated from the biological data, is identical to the Euclidian distance ∥g−p∥² between the transformed templates g and p using the transforming method according to the present embodiment as shown in Equation 5.

$$\begin{matrix}‖ g - p ‖ 2 = {( g - p )}^{T} ( g - p ) \\ = {( Ax + b - Ay - b )}^{T} ( Ax + b - Ay - b ) \\ = {( Ax - Ay )}^{T} ( Ax - Ay ) \\ = {( x - y )}^{T} {A}^{T} A ( x - y ) \\ = {( x - y )}^{T} I ( x - y ) \\ = {‖ x - y ‖}^{2}\end{matrix} \qquad Equation 5$$

That is, comparing the transformed templates g and p is identical to comparing the templates x and y, which are directly generated from a user's biological data. Therefore, it does not require to restore the template x from the transformed template g for comparing the templates, and it can be used without modifying conventional biometric systems in order to improve their security for protection of users' biological data. In addition, the same biological data can be used in order to create a new template in case that a transformed template is disclosed, in contrary to encoding and storing users' templates using cryptography because the proposed method performs matching process in the transformed state and the transformation can be altered whenever it is necessary.

If the template p is created without accurate information about the random orthogonal matrix A and random vector b, which were used to generate the template g, the value of ∥g−p∥² is extremely getting larger than the value of ∥x−y∥² due to the mismatch of A and b. Therefore, the biometric system may determine a user as an impostor more reliably. That is, in order to authenticate a user as a genuine, accurate biological data, random orthogonal data A and random vector b must be obtained. Therefore, the method and apparatus for biometrics according to the present embodiment can be used to embody an authentication system providing with higher satiability compared to the conventional biometric systems.

The processor 350 performs user authentication processes based on the result of the authentication comparison unit 340. For example, the processor 350 notices the success of the authentication to a user or allows a related right to a user. Or the processor 350 informs the user of authentication failure and asks to follow the authentication procedure again.

The transform key storing unit 200 is an apparatus that is independently provided from the user and the user registration unit 100 and the user authentication unit 300 for increasing the stability of the biometric apparatus according to the present invention and the reliability of user's privacy. The transform key storing unit 200 includes a random orthogonal matrix generation unit 210 and a random vector generation unit 220 for providing a random orthogonal matrix and a random vector to the registration template transform unit 130 and the authentication template transform unit 330 as a same transform key. The transform key storing unit 200 also creates random orthogonal matrixes and random vectors differently according to each user requesting the authentication in order to increase the stability of the biometric apparatus according to the present invention and the reliability of user's privacy. In this case, it is preferable that the transform key storing unit 200 is a personal storage device such as a smart card.

The transform storing unit 200 can receive information about formats of a first registration template x or a first authentication template y from the registration template generation unit 120 or the authentication template generation unit 320 in order to create a random orthogonal matrix and a random vector to perform transformation shown in Equation 3 and Equation 4.

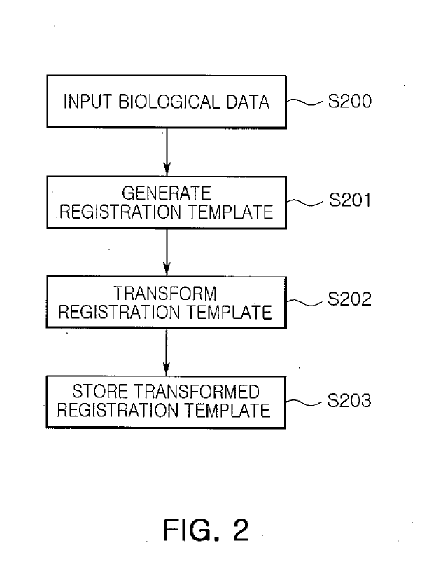

FIG. 2 is a flowchart illustrating a method of transforming a registration template according to another embodiment of the present invention.

Referring to FIG. 2, the biological data of a user is received for storing the biological data of a target user for biometric recognition at step S200. Then, a first registration template is generated based on the received biological data at step S201. In order to create the first template, a biometric entry is measured, such as a user's face, eyes, hands or voice. Then, a first registration template having a predetermined standard data form is created to be used for the user authentication after obtaining a unique value of each entry. The type of the first registration template can vary according to the type of the biological data. In the present embodiment, it is preferable that the template is a real number vector.

Then, the first registration template is transformed to a second registration template at S202 in order not to expose the biological data of a user contained in the template although a registration template stored in a biometric system is disclosed to outside. Herein, the first registration template x is transformed to a second registration template g using a method g=Ax+b using a random orthogonal matrix A and a random vector b.

After obtaining the second registration template, the second registration g is stored for biometric recognition instead of storing the first registration template x at step S203. Then, the first registration template x is dumped.

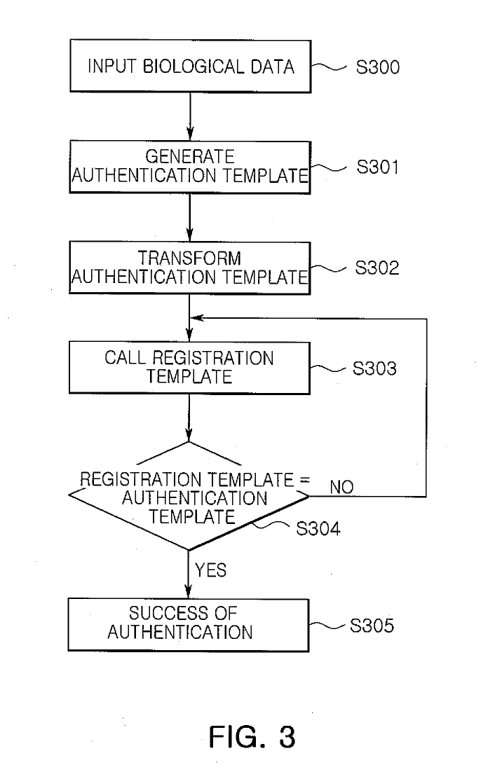

FIG. 3 is a flowchart illustrating a method of biometrics according to another embodiment of the present invention.

Referring to FIG. 3, biological data is received from a user requesting the biometric recognition at step S300. Then, a first authentication template is created based on the received biological data at step S301. The type of the first authentication template can be different according to the type of the biological data. In the present embodiment, it is preferable that the first authentication template is a real number vector.

Then, the first authentication template is transformed to a second authentication template using a random orthogonal matrix and a random vector at step S302. Herein, the first authentication template y is transformed to the second authentication template p using a method of p=Ay+b using a random orthogonal matrix A and a random vector b.

Then, the second authentication template from the step S302 and the second registration template, which is transformed by the same transforming method and stored at the step S202, are called at step S303. The second authentication template is compared with the second registration template at step S304. If there is the second registration template matched with the second authentication template of the user requesting authentication, the user authentication is success at step S305.

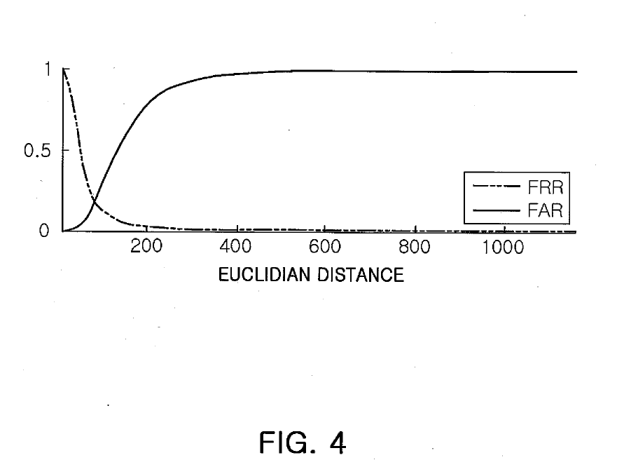

Hereinafter, the influence of the present invention to the reliability of biometric recognition will be described with reference to FIG. 4 to FIG. 6.

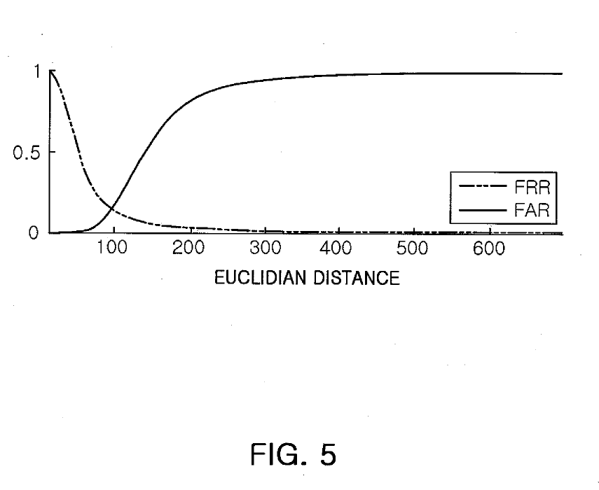

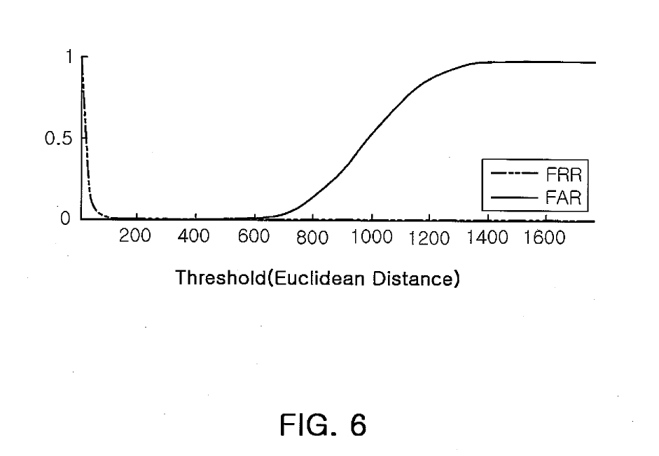

FIG. 4 is a graph showing a result of authenticating a face using Eigefnace, which is widely known a face template generation method, with a false rejection rate (FRR) and a false accept rate (FAR). FIG. 5 is a graph showing a result of authenticating a face using the Eigefnace with an authentication scheme proposed by Jeonil Kang, DaeHun Nyan, and KyungHee Lee in an article entitled “Two Factor Face Authentication Scheme with Cancelable Feature”, LNCS Vol. 3781, Page, 67-76. FIG. 6 is a graph showing a result of authentication a face using a biometrics method according to an embodiment of the present invention. In FIG. 5 and FIG. 6, different transform keys are generated for each user according to proposed corresponding methods, and used for transforming a template.

Herein, face image data consist of 55 people and 20 images per person. Ten pictures of each person are used to generate a base vector and gallery, and other ten pictures of each person are used to test. In order to create a gallery, features are extracted from 10 pictures of each person, and an average thereof is obtained to create one gallery. That is, a simulation is performed using 55 galleries and 550 probes. An Euclidian distance is used for comparing the templates.

In case of FIG. 4, an equal error rate is about 18.18%. Also, an equal error rate is about 14.73% in FIG. 5, and an equal error rate is about 0% in FIG. 6.

Dislike from the present embodiment, the simulation of FIG. 5 uses a method of creating a transformed template by mixing only orders of facial features when a template is created from biological data. Therefore, it is not effective to reduce the equal error rate. In order to reduce the equal error rate, a Euclidian distance between templates of different persons becomes further longer. However, there is not much difference in the Euclidian distance between templates of different two persons if the transformed template is created by mixing only the order of facial features.

That is, a first registration template x denotes is a registration template of a genuine before transformation, a first authentication template y denotes an authentication template of a genuine before transformation, a first authentication template y′ denotes an authentication template of an impostor before transformation, a random matrix A′ denotes a random matrix used by the impostor and a random vector b′ denotes a random vector used by the impostor. In the method used in FIG. 5, a permutation matrix Aₚ is used to transform the template as like Equation 6. If the permutation matrix A_{P} is multiplied to a vector, the order of vector elements is changed.
g=AₚX, p=Aₚy Equation 6

However, the template is transformed by using a random orthogonal matrix A and a random vector b in an exemplary embodiment of the present invention as like g=Ax+b, and p=Ay+b.

In order to clearly distinguish a genuine from an imposter, it must have a small Euclidian distance value when comparing the biologic templates of a same person, or have a large Euclidian distance value when comparing the biologic templates of different persons. That is, the false accept rate becomes reduced when ∥x−y∥ is small and ∥x−y′∥ is large.

The Euclidian distance for an impostor, calculated using the method of FIG. 5, is shown in Equation 7.
∥g−p′∥−∥Aₚx−Aₚy∥ Equation 7
Here, Aₚ′ denotes a permutation matrix used by the impostor.

The Euclidian distance for an impostor, calculated using the method according to the present embodiment, is shown in Equation 8.
∥g−p′∥=∥Ax+b−A′y′−b′∥ Equation 8

Herein, since the norm of a row and a column in the random orthogonal matrix, which includes a permutation matrix, is 1, the value of the random orthogonal matrix is not large. Also, the difference from two different random orthogonal matrixes is not large too. Therefore, the value of ∥g−p′∥−∥Aₚx−Aₚy∥ in Equation 7 is not much different from ∥x−y′∥. Therefore, the conventional method is not effective to reduce the false accept rate.

The random vector b used in the present embodiment is not limited in its size differently from the random orthogonal matrix A. Therefore, the value of ∥g−p′∥ can be made sufficiently larger than the value of ∥x−y′∥, if a random vector b having sufficiently large displacement is used. Thus, the false accept rate can be reduced to 0 according to the present embodiment.

Although the conventional permutation vector only changes the order of the vector elements, the random orthogonal matrix used in the present embodiment not only changes the order of the vector elements but also changes the values of the vector elements. Therefore, it is more effective to hide the original template.

As set forth above, according to preferred embodiments of the invention, a false accept rate is reduced in a biometric authentication, and it is possible to authenticate a user while safely storing biological data of a user. Also, it prevents an unauthorized user from analogizing biological data of a user from a template although templates for authentication are disclosed. Furthermore, it allows a new template to create from an identical biological data of a user although the biological data is disclosed.

While the present invention has been shown and described in connection with the preferred embodiments, it will be apparent to those skilled in the art that modifications and variations can be made without departing from the spirit and scope of the invention as defined by the appended claims.

What is claimed is:

1. A method for transforming a registration template comprising:
generating a first registration template from biological data inputted from a user who is a target for biometric recognition;
transforming the first registration template to a second registration template using a random orthogonal matrix and a random vector; and
storing the second registration template at a storing unit to be used for biometric recognition and dumping the first registration template that is directly generated from the biological data of a user.

2. The method according to claim 1, wherein in the step of generating the first registration template, the first registration template is a real number vector.

3. The method according to claim 1, wherein in the step of transforming the first registration template to the second registration template, the first registration template is transformed to the second registration template by following Equation:
g=Ax+b,
where g denotes the second registration template, A denotes a random orthogonal matrix, x denotes the first registration template, and b denotes random vector.

4. A method of authenticating a user comprising:
generating a first authentication template from biological data inputted from a user requesting biometric recognition;
transforming the first authentication template to a second authentication template using a random orthogonal matrix and a random vector; and
comparing the second authentication template with a second registration template that is transformed by the same method of transforming the first authentication template to the second authentication template and stored.

5. The method according to claim 4, wherein in the step of transforming the first authentication template to the second authentication template, the first authentication template is transformed to the second authentication template by following Equation:
p=Ay+b,
Where p denotes the second authentication template, A denotes a random orthogonal matrix, y denotes the first authentication template that is directly generated from user's biological data, and b denotes a random vector.

6. The method according to anyone of claim 4, wherein the random orthogonal matrix and the random vector used in the step of transforming the first authentication template to the second authentication template are identical to those used in the step of transforming the first registration template to the second registration template.

7. The method according to claim 4, wherein in the step of comparing, an authentication is performed by calculating a Euclidian distance between the second authentication template and the second registration template.

8. An apparatus for biometrics comprising:
a user registration unit for generating a first registration template from biological data from a user, transforming the first registration template to a second registration template using a random orthogonal matrix and a random vector, and storing the second registration template;
a user authentication unit for generating a first authentication template from biological data from a user, transforming the first authentication template to a second authentication template using the random orthogonal matrix and the random vector used in the user registration unit, and performing user authentication by comparing the second authentication template with the second registration template stored in the user registration unit; and
a transform key storing unit for providing a random orthogonal matrix and a random vector to the user registration unit and the user authentication unit as a transform key for template transformation.

9. The apparatus according to claim 8, wherein the user registration unit includes:
a user biological data input unit for measuring a biometric entry of a user and obtaining biological data for each entry;
a registration template generating unit for generating an unique value using the biological data obtained from the biological data input unit, and generating a first registration template using the generated unique value;
a registration template transform unit for transforming the first registration template to a second registration template using a random orthogonal matrix and a random vector provided from the transform key storing unit not to expose the biological data contained in the template although a registration template stored in a biometric system is disclosed to outside; and
a storing unit for storing the second registration template from the registration template transform unit.

10. The apparatus according to claim 9, wherein the first registration template generated from the registration template generation unit.

11. The apparatus according to one of claim 9, wherein the registration template transform unit transforms the first registration template to the second registration template by following Equation:
g=Ax+b,
where g denotes the second registration template, A denotes a random orthogonal matrix, x denotes the first registration template, and b denotes random vector.

12. The apparatus according to claim 9, wherein the storing unit stores only the second registration template generated from the registration template transform unit instead of storing the first registration template directly generated from the user biological data.

13. The apparatus according to claim 9, wherein the user authentication unit includes:
a user biological data input unit for measuring a biometric entry of a user and obtaining biological data of each entry;
an authentication template generation unit for generating an unique value using the biological data obtained from the user biological data input unit, and generating a first authentication template using the obtained biological data;
an authentication template transform unit for transforming the first authentication template to a second authentication template using the same method of transforming the first registration template to the second registration template in the user registration unit;
an authentication comparing unit for comparing the second authentication template generated from the authentication template transform unit with the second registration template stored in the user registration unit for authenticating a user requesting biometric recognition; and
a processor for performing operations related to user authentication based on results from the authentication comparing unit.

14. The apparatus according to claim 13, wherein the biological data input unit and the authentication template generation unit use devices having a structure and interface similar to those in the user biologic data input unit and the registration template generation unit in the user registration unit so at to operate identically for the biological data of the same user.

15. The apparatus according to claim 13, wherein the authentication comparison unit calculates an Euclidian distance between the second authentication template generated from the authentication template transform unit with the second registration template stored in the storing unit of the user registration unit for user authentication.

16. The apparatus according to one of claim 8, wherein the transform key storing unit includes:
a random orthogonal matrix generation unit for providing a random orthogonal matrix to the user registration unit and the user authentication unit as a same transform key; and
a random vector generation unit for providing a random vector to the user registration unit and the user authentication unit as a same transform key.

17. The apparatus according to one of claim 8, wherein the transform key storing unit is independently provided from the user registration unit and the user authentication unit.
